(19) United States
(12) Patent Application Publication
(10) Pub. No.: US 2026/0075543 A1
(43) Pub. Date: Mar. 12, 2026

(54) RS BUNDLING FOR EH WIRELESS DEVICES

(71) Applicant: QUALCOMM Incorporated, San Diego, CA (US)

(72) Inventors: Ahmed ELSHAFIE, San Diego, CA (US); Yuchul KIM, San Diego, CA (US); Zhikun WU, Beijing (CN); Linhai HE, San Diego, CA (US); Huilin XU, Temecula, CA (US); Krishna Kiran MUKKAVILLI, San Diego, CA (US); Tingfang JI, San Diego, CA (US)

(21) Appl. No.: 19/106,600

(22) PCT Filed: Sep. 23, 2022
(86) PCT No.: PCT/CN2022/120807

§ 371 Date: Feb. 25, 2025

(51) Int. Cl. H04W 52/32; H04B 7/06; H04L 5/00; H04L 27/26

(52) U.S. Cl. CPC H04W 52/32; H04B 7/0626; H04L 5/0044; H04L 5/0055; H04L 27/261

(57) ABSTRACT

Apparatus, methods, and computer program products for wireless communication with reference signal bundling are provided. An example method may include receiving, from a second wireless device, a configuration for a set of bundled reference signals (RSs), where the set of bundled RSs is periodic or semi-persistent, where the set of bundled RSs is associated with a plurality of occasions. The example method may further include transmitting, for the second wireless device before a subsequent occasion of the plurality of occasions, an indication representing whether the first wireless device is able to maintain a transmit power for the subsequent occasion of the plurality of occasions.

### TECHNICAL FIELD

The present disclosure relates generally to communication systems, and more particularly, to wireless communication systems with energy harvesting.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first wireless device (e.g., a user equipment (UE) or a network entity) are provided. The apparatus may include a memory and at least one processor coupled to the memory. The memory and the at least one processor coupled to the memory may be configured to receive, from a second wireless device, a configuration for a set of bundled reference signals (RSs), where the set of bundled RSs is periodic or semi-persistent, where the set of bundled RSs is associated with a plurality of occasions. The memory and the at least one processor coupled to the memory may be further configured to transmit, for the second wireless device before a subsequent occasion of the plurality of occasions, an indication representing whether the first wireless device is able to maintain a transmit power for the subsequent occasion of the plurality of occasions.

In another aspect of the disclosure, a method, a computer-readable medium, and an apparatus at a second wireless device (e.g., a UE or a network entity) are provided. The apparatus may include a memory and at least one processor coupled to the memory. The memory and the at least one processor coupled to the memory may be configured to transmit, for a first wireless device, a configuration for a set of bundled RSs, where the set of bundled RSs is periodic or semi-persistent, where the set of bundled RSs is associated with a plurality of occasions. The memory and the at least one processor coupled to the memory may be further configured to receive, before a subsequent occasion of the plurality of occasions, an indication representing whether the first wireless device is able to maintain a transmit power for the subsequent occasion of the plurality of occasions.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example backscatter communication.

FIG. 5 is a diagram illustrating example backscatter communication with interrogator-talks-first (ITF) procedure between reader and tag.

FIG. 6 is a diagram illustrating example bundling of reference signals (RSs).

FIG. 7 is a diagram illustrating example communications between a first wireless device and a second wireless device.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

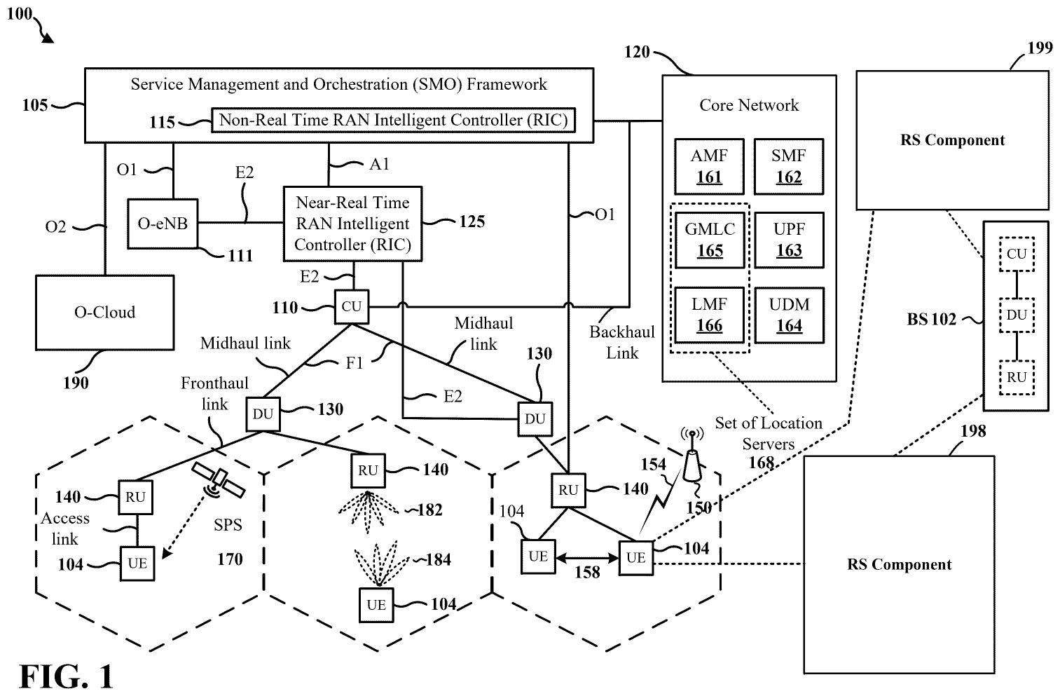

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include an RS component 198. In some aspects, the RS component 198 may be configured to receive, from a second wireless device, a configuration for a set of bundled RSs, where the set of bundled RSs is periodic or semi-persistent, where the set of bundled RSs is associated with a plurality of occasions. In some aspects, the RS component 198 may be further configured to transmit, for the second wireless device before a subsequent occasion of the plurality of occasions, an indication representing whether the first wireless device is able to maintain a transmit power for the subsequent occasion of the plurality of occasions.

In certain aspects, the base station 102 may include an RS component 199. In some aspects, the RS component 199 may be configured to transmit, for a first wireless device, a configuration for a set of bundled RSs, where the set of bundled RSs is periodic or semi-persistent, where the set of bundled RSs is associated with a plurality of occasions. In some aspects, the RS component 199 may be further configured to receive, before a subsequent occasion of the plurality of occasions, an indication representing whether the first wireless device is able to maintain a transmit power for the subsequent occasion of the plurality of occasions.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

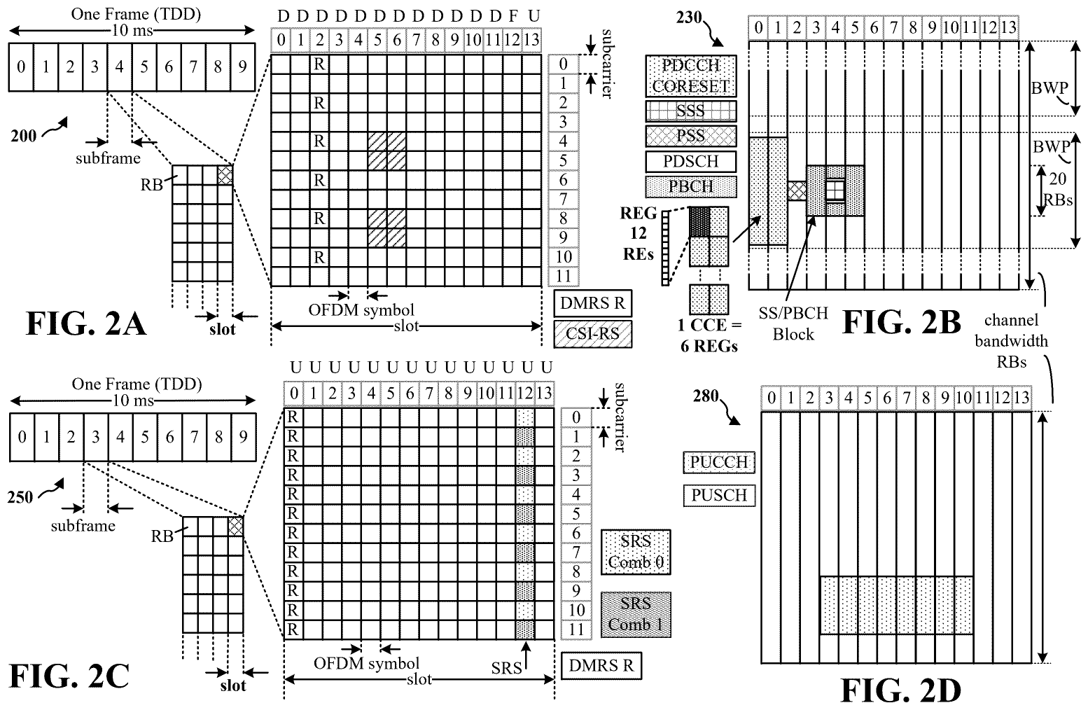

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

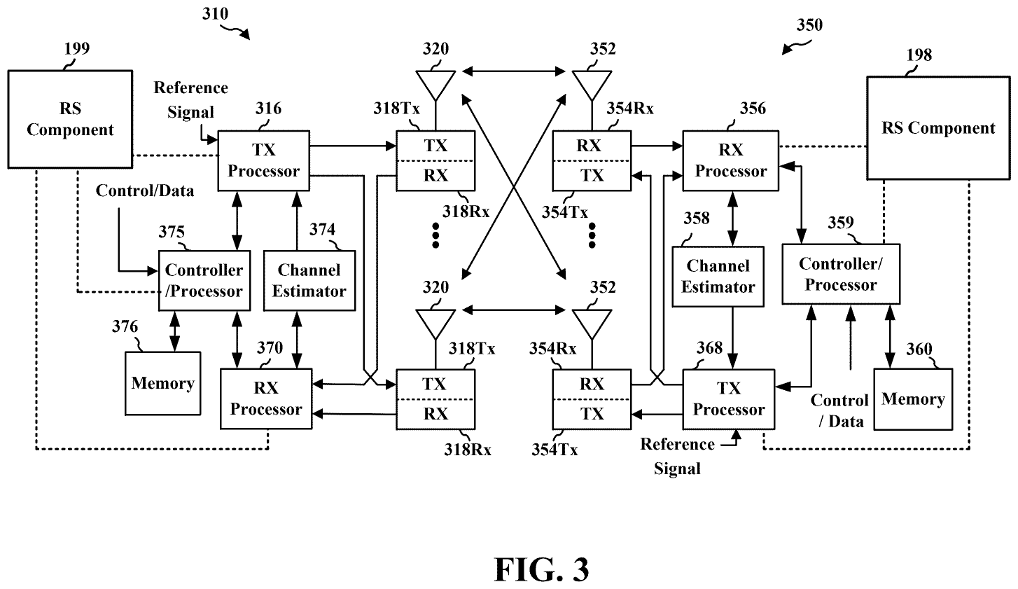

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with RS component 198 of FIG. 1.

At least one of the TX processor 316, the RX processor 370, and the controller/processor 375 may be configured to perform aspects in connection with RS component 199 of FIG. 1.

In addition to higher capability devices, wireless communication may support reduced capability (RedCap) devices. Among others, examples of higher capability devices include premium smartphones, V2X devices, URLLC devices, eMBB devices, etc. Among other examples, reduced capability devices may include wearables (e.g., such as smart watches, augmented reality glasses, virtual reality glasses, health and medical monitoring devices, etc.), industrial wireless sensor networks (IWSN) (e.g., such as pressure sensors, humidity sensors, motion sensors, thermal sensors, accelerometers, actuators, etc.), surveillance cameras, low-end smartphones, etc. For example, NR communication systems may support both higher capability devices and reduced capability devices. A reduced capability device may be referred to as an NR light device, a low-tier device, a lower tier device, etc. Reduced capability UEs may communicate based on various types of wireless communication. For example, smart wearables may transmit or receive communication based on low power wide area (LPWA)/mMTC, relaxed IoT devices may transmit or receive communication based on URLLC, sensors/cameras may transmit or receive communication based on eMBB, etc.

In addition to reduced capability devices, devices with a lower capability than reduced capability devices including lower power consumption and a less complicated structure may be included in wireless communication systems. In some wireless communication systems, passive wireless devices such as zero-power passive IoT wireless devices may be included. Such passive wireless devices may be without active RF components and may perform transmissions based on backscatter communication and may perform reception based on envelope detection or an envelope detector. Backscatter communication may modulate information on an incoming RF signal (which may be a carrier wave that may carry communication between other devices) by an adaptation of antenna load impedance. A passive wireless device may be battery-less or battery assisted. For example, a passive wireless device may operate based on energy harvesting from an incoming radio wave with or without a battery as an additional power source. A passive wireless device may have low power consumption, such as between 1 microwatt to 1000 microwatts. Such passive wireless devices may be devices for inventory management, wireless sensors, or the like. Passive devices may use backscatter communication to communicate with another network entity, such as a base station.

Backscatter communication may enable radio frequency identification (RFID). For example, a reader may send a continuous waveform signal and interrogate commands. An RF tag (which is a passive wireless device) may harvest energy from the continuous waveform signal and may respond to the interrogation by varying its input impedance (e.g., between conjugate match and strongly mismatched), therefore modulating the backscattered signals. RFID is a rapidly growing technology impacting many industries due to its potential for inventory/asset management inside and outside warehouse, IoT, sustainable sensor networks in factories and/or agriculture, and smart home. RFID may include small transponders, which may be referred to as tags, emitting an information-bearing signal upon receiving a signal. RFID may be operated without battery at low operational expenditures (OPEX) and may use small amount of resources. RFID may have use lower amount of maintenance and may have a long life-cycle.

As used herein, the term “energy transfer” transfer may be used interchangeably with “energy harvesting” (EH) to refer to a procedure in which a wireless device (which may be referred to as an “energy harvesting wireless device”) uses a carrier wave transmitted by another wireless device (which may be referred to as a “power provider wireless device” to get energy). An example of an energy harvesting (EH) device may be a RF tag and an example of a power provider (PP) wireless device may be a RF interrogator (which may also be referred to as “RF reader”). Examples of an energy harvesting wireless device may include energy harvesting UEs, RFID tag with battery, RFID tag without battery, or other types of wireless devices with energy harvesting capability (e.g., based on any sources such as laser provided by network or other sources such as solar, thermal, vibration, RF from NW or other sources including various types of wireless communications). In some aspects, the energy harvesting wireless device may be a UE with a modem and may be capable of performing energy harvesting. As used herein, the term “bundled RSs” may refer to multiple RSs configured to have a coherency (e.g., phase continuity) based on a same frequency resource allocation, a same transmit power (e.g., which may include an amount of allowed delta reduction of power), a same spatial transmission relation, a same set of antenna ports, and a same precoding. As used herein, the term “maintain a transmit power” may be used to refer to maintain a transmit power above a first power threshold (e.g., based on a power of a first transmission in multiple occasions or a configured transmit power), equal to a specified power (with fluctuation allowed), above a power threshold (such as above a specified power minus an allowed delta reduction of power), or the like. As used herein, the term “occasion” may refer to one instance with one duration where one RS or a set of RSs are transmitted. For periodic or semi-persistent set of RSs, there may be multiple occasions where the set of RSs are transmitted. The multiple occasions of RSs may be associated with a periodicity. As used herein, the term “subsequent occasion” may refer to the next occasion (e.g., the upcoming occasion). For example, if a wireless device has transmitted RSs in a first occasion and a second occasion, the subsequent occasion may be the third occasion. As used herein, the term “energy state” (which may also be referred to as “energy mode”, “energy information”, or “energy status”) may refer to one or more of: an energy level profile representing available energy at a device's energy storage unit or battery over time based on current measurements and prediction over time (e.g., current available energy, predicted future available energy and associated predicted time instances or durations, or the like), an energy charging profile representing energy charging rate or other energy charging related parameters related to the device's energy storage unit or battery (e.g., a current energy charging rate, predicted future energy charging rates and associated predicted time instances or durations, or the like), an energy discharging profile representing energy discharging rate (e.g., a current energy discharging rate, predicted future energy discharging rates and associated predicted time instances or durations, or the like), or other energy discharging related parameters related to the device's energy storage unit or battery. For example, an energy charging profile may include a current measured charging rate, how long the current charging rate is predicted to last, a predicted charging rate for one or more future time instances or durations, or the like. As one example, the energy charging profile may include P1, P2, P3, P4, . . . , PN (each of which represent an energy charging rate and T1 (time instance or duration predicted for charging rate P1 to last), T2 (time instance or duration predicted for charging rate P2 to last), T3 (time instance or duration predicted for charging rate P3 to last), T4 (time instance or duration predicted for charging rate P4 to last), . . . , TN (time instance or duration predicted for charging rate PN to last). In some aspects, based on an agreement with two wireless devices (such as a UE and a gNB or between two UEs), a wireless device may decide based on the profiles (e.g., and the values in each profile including P1, P2, . . . , PN, the parameters, T1, T2, . . . , TN) for each profile of the energy charging profile, the energy discharging profile, or the energy level profile. In some aspects, the term “cancel” may refer to a scenario where there is RS transmission but no DM-RS, SRS, or other RS bundling (e.g., due to power being different and potentially no coherency) or a scenario where the RS transmission and a transmission (e.g., an associated PUSCH) is not transmitted (e.g., due to having not enough power for transmission).

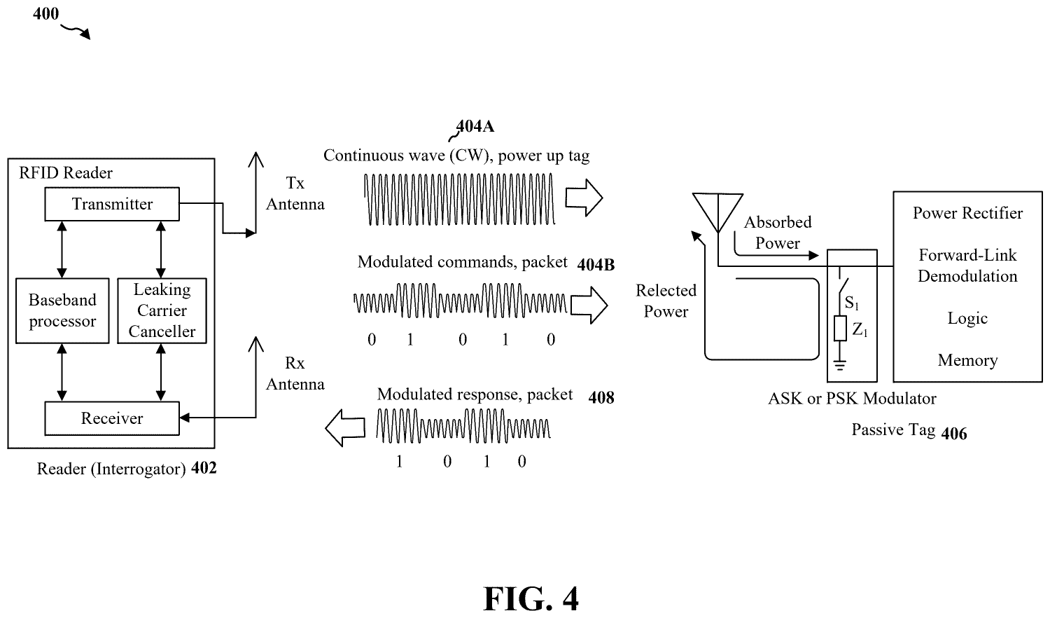

FIG. 4 is a diagram 400 illustrating example backscatter communication. As illustrated in FIG. 4, a RF reader 402 may transmit a continuous wave (CW) 404A for powering up a RF tag 406. Based on the continuous wave 404A, the RF tag 406 may be powered on. The RF reader 402 may also transmit a wave carrying modulated commands 404B to the RF tag 406 (e.g., by modulating the CW). Based on the energy gathered from the wave carrying the modulated commands 404B, the RF tag may transmit (e.g., by modulating and reflecting) modulated response 408 to the RF reader.

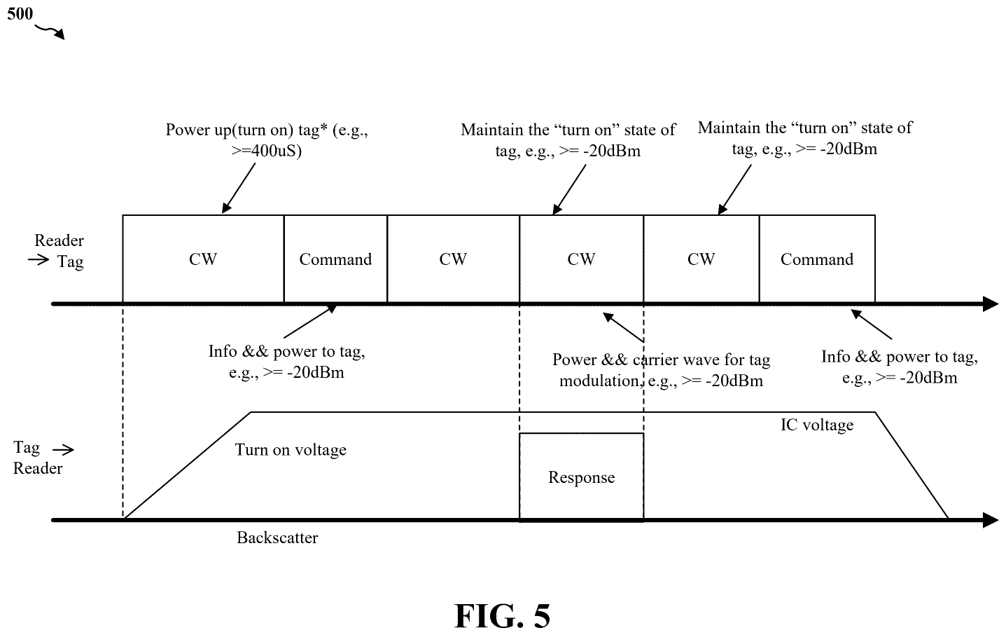

FIG. 5 is a diagram 500 illustrating example backscatter communication with interrogator-talks-first (ITF) procedure between reader and tag. In some instances, the interrogator in the IRF procedure may be the reader. As illustrated in FIG. 5, the CW may be transmitted by the reader for powering on the tag. After powering on the tag, the reader may transmit a command, and then maintain the CW to keep the tag on.

If a wireless device is a PP UE to other sidelink/wearable/UEs in the network, the PP-UE may send best resources for each of the specific UEs it is helping (e.g., when those UEs are utilizing time-switching energy harvesting architecture). In some aspects, the concept of inter-UE coordination may be extended for indicating UEs with the suitable or unsuitable resources used for data communication or energy transfer (e.g., that may be used to power the EH UE). For example, a PP UE may inform one or more EH UEs that some time and frequency resources (e.g., that may be carrying another transmission) may be leveraged as energy source, even though the time and frequency resources are not carrying a dedicated energy signal. In some aspects, a PP UE may be assigned to power a number of EH UEs, where each of the EH UEs may be located in different locations and may have a difference distance from the PP UE. Charging rate of the EH UEs may be the same or different. The energy harvested or charging rate at an EH wireless device may be: P=ηPₜₓ|h|² Watts or E=P T Joules, where η represents RF-to-DC conversion efficiency, Pₜₓ represents the Tx radiated power, h represents channel coefficient (small- and large-scale fading), and T represents the total allocated time. If η is higher, more energy may be harvested and accumulated over time. The RF-to-DC conversion efficiency η may depend on circuit design, antenna efficiency, efficiency of voltage multiplier to convert RF to DC, accuracy of impedance matching between antenna and voltage multiplier, or the like. Increasing the transmit radiated power, Pₜₓ, may also increase the transferred power. Increasing charging time, T, may increase the accumulated energy at the EH wireless device.

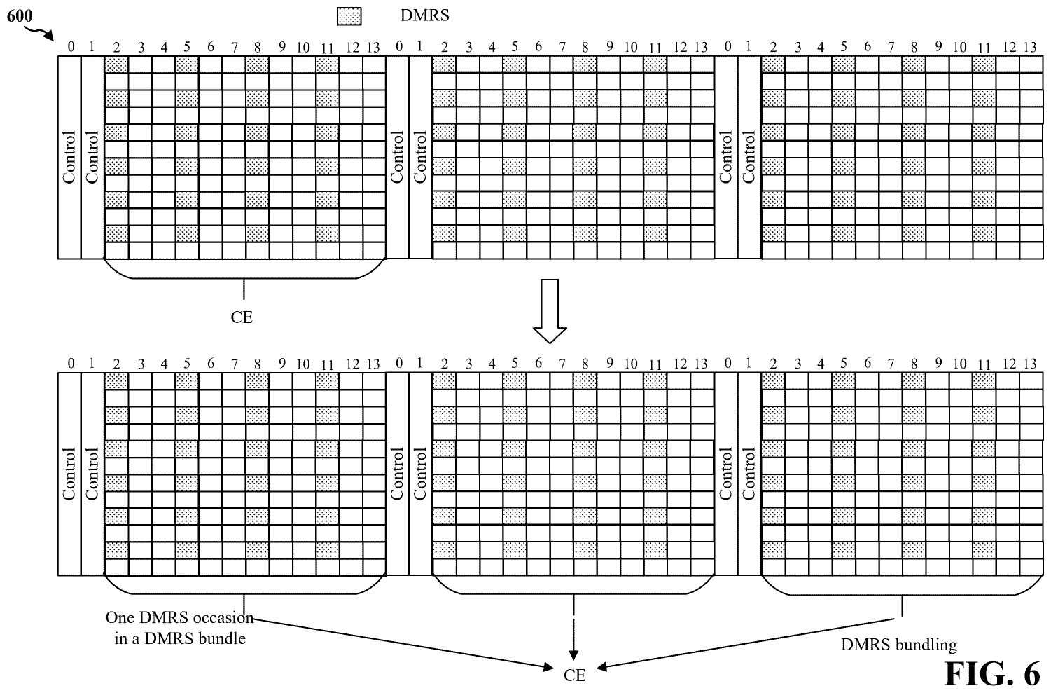

FIG. 6 is a diagram 600 illustrating example bundling of RSs. As illustrated in FIG. 6, DM-RSs in multiple UL or SL transmissions may be bundled and processed together. In some aspects, the multiple UL or SL transmissions may be multiple PUSCH or PSSCH transmissions. In some aspects, the multiple UL or SL transmissions may be multiple PUCCH or PSCCH transmissions. To bundle the DM-RSs in the multiple UL or SL transmissions, a transmitting entity of the multiple DM-RSs may maintain coherency (e.g., phase continuity) across the multiple UL or SL transmissions. For example, to maintain the phase continuity, the transmitting entity of the multiple DM-RSs use a same frequency resource allocation, a same transmit power, a same spatial transmission relation, a same set of antenna ports, or a same precoding to transmit the multiple UL or SL transmissions. For an EH wireless device, such as an EH UE to transmit such UL or SL transmissions that have coherency (e.g., phase continuity), a same power level or a same set of antennas may be used for all of the UL or SL transmissions. However, the EH wireless device may be unable to transmit all of the RSs in the UL or SL transmissions with a same power level or a same set of antennas due to running out of energy or other reasons. Aspects provided herein provide signaling mechanisms for communication between EH wireless device and non-EH wireless device to address potential issues that may be caused by the EH wireless device being unable to maintain a transmit power for bundled RSs.

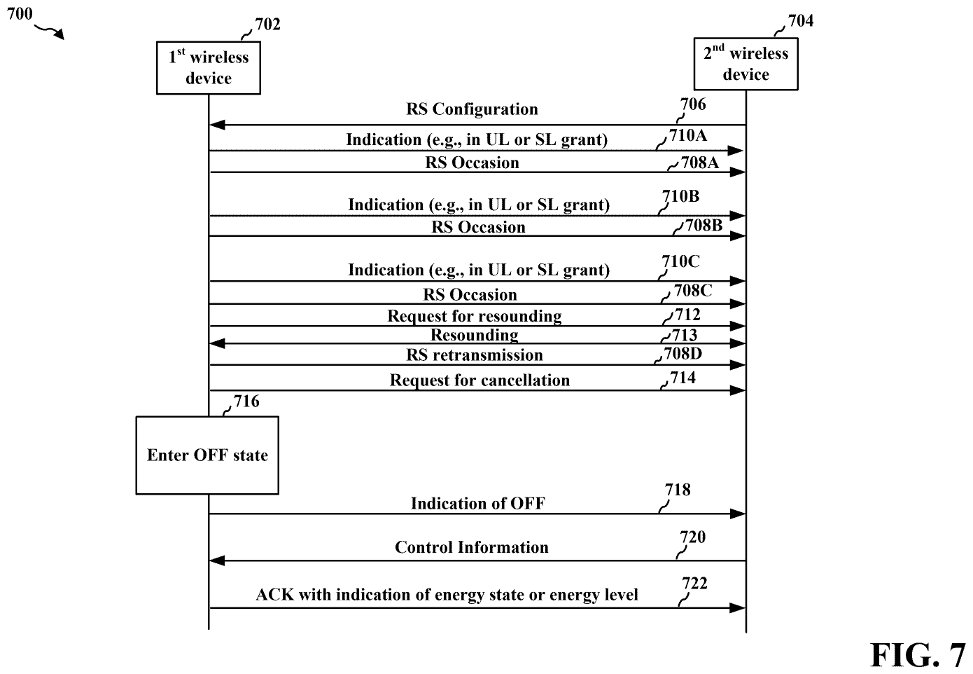

FIG. 7 is a diagram 700 illustrating example communications between a first wireless device 702 and a second wireless device 704. The wireless device 702 may be a EH wireless device. Examples of the EH wireless device may include energy harvesting UEs, RFID tag with battery, RFID tag without battery, or other types of wireless devices with energy harvesting capability (e.g., based on any sources such as laser provided by network or other sources such as solar, thermal, vibration, RF from NW or other sources including various types of wireless communications). In some aspects, the energy harvesting wireless device may be a UE with a modem and may be capable of performing energy harvesting. In some aspects, the wireless device 702 may be a UE. In some aspects, the wireless device 702 may be a network entity. The wireless device 704 may be a non-EH wireless device. In some aspects, the wireless device 704 may be a UE. In some aspects, the wireless device 704 may be a network entity or a UE. In some aspects, a network entity may be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC. In some aspects, communications between the wireless device 702 and the wireless device 704 may be downlink communication, uplink communication, sidelink communication, or the like.

As illustrated in FIG. 7, in some aspects, the wireless device 702 may be configured with, such as by receiving an RS configuration 706 from the wireless device 704, a set of bundled RSs. In some aspects, the set of bundled RSs may be periodic or semi-persistent. In some aspects, the set of bundled RSs may be aperiodic. Semi-persistent may refer to a scheduling where a serving network entity configures a wireless device with a part of resources and formats semi-statically over a time interval. In some aspects, the set of bundled RSs may be a set of DM-RSs. In some aspects, the set of bundled RSs may be a set of SRSs. In some aspects, the set of bundled RSs may be a set of positioning reference signals (PRSs). In some aspects, the set of bundled RSs may be periodic or semi-persistent and may include multiple occasions including RS occasion 708A, RS occasion 708B, and RS occasion 708C. As an example, in some aspects, the wireless device 702 may be able to transmit the RSs in the RS occasion 708A. In some aspects, the wireless device 702 may be able to transmit the RSs in the RS occasion 708B. In some aspects, to transmit the set of bundled RSs, the wireless device 702 may transmit multiple transmissions that include the set of RSs based on a same frequency resource allocation, a same transmit power, a same spatial transmission relation, a same set of antenna ports, or a same precoding.

As used herein, the term “maintain a transmit power” may be used to refer to maintain a transmit power above a first power threshold and below a second power threshold, equal to a specified power (with fluctuation allowed), above a power threshold (such as above a specified power minus an allowed delta reduction of power), or the like. In some aspects (e.g., to address potential issues that may be caused by the EH wireless device being unable to maintain a transmit power for bundled RSs), the wireless device 702 may be configured to transmit an indication (e.g., in a latest UL or SL grant) representing whether the wireless device 702 would be able to maintain the transmit power (e.g., and other conditions for coherency such as same frequency resource allocation, a same spatial transmission relation, a same set of antenna ports, a same precoding, or the like) before each new occasion of the bundled RSs. For example, before the RS occasion 708A, the wireless device 702 may transmit an indication 710A representing that the wireless device 702 is able to maintain transmit power (e.g., and coherency) for transmitting multiple transmission carrying bundled RSs in the RS occasion 708A to the wireless device 704. In some aspects, based on the indication 710A, the wireless device 704 may be aware of and may receive the multiple transmission carrying bundled RSs in the RS occasion 708A accordingly. Similarly, before the RS occasion 708B, the wireless device 702 may transmit an indication 710B representing that the wireless device 702 is able to maintain transmit power (e.g., and coherency) for transmitting multiple transmission carrying bundled RSs in the RS occasion 708B to the wireless device 704. In some aspects, based on the indication 710B, the wireless device 704 may be aware of and may receive the multiple transmission carrying bundled RSs in the RS occasion 708B accordingly. In some aspects, the set of bundled RSs may be SRS, DM-RS, or the like, and the coherency may be intra-slot or inter-slot. In some aspects, the indication 710B may represent that the wireless device 702 is able to maintain transmit power (e.g., and coherency) for intra-slot or inter-slot transmission.

In some aspects, before the RS occasion 708C, the wireless device 702 may transmit an indication 710C representing that the wireless device 702 is unable to maintain transmit power (e.g., and coherency) for transmitting multiple transmission carrying bundled RSs in the RS occasion 708C to the wireless device 704. In some aspects, because the wireless device 702 may be unable to maintain transmit power (e.g., and coherency) for transmitting multiple transmission carrying bundled RSs in the RS occasion 708C to the wireless device 704, the wireless device 702 may transmit a request 712 for resounding one or more antenna ports at the wireless device 702. The term “sounding” may refer to a process of evaluating the radio environment for wireless communication and processing the multidimensional spatial-temporal signal and estimate channel characteristics to enable wireless transmissions. The term “resounding” may refer to a process of reevaluating the radio environment for wireless communication and reprocessing the multidimensional spatial-temporal signal and estimate channel characteristics to enable wireless transmissions. In some aspects, a message carrying the request 712 for resounding one or more antenna ports at the wireless device 702 may also include information regarding which ports at the wireless device 702 have been sounded or which CSI-RS resources have been received. In some aspects, a message carrying the request 712 may be transmitted on configured or dedicated resources after a sounding process (e.g., for CSI-RS, may be part of CSI report). In some aspects, the indication 710A, the indication 710B, or the indication 710C may be transmitted based on signaling on layer 1 (L1), layer 2 (L2), or layer 3 (L3), where L1 may be the PHY layer, L2 may be the MAC layer or the logical link control layer, and L3 may be the network layer. In some aspects, the indication 710A, the indication 710B, or the indication 710C may be transmitted in or bundled with UE assistance information (UAI), buffer status report (BSR), scheduling request (SR), a hybrid automatic repeat request (HARQ) acknowledgment (ACK), a power headroom report (PHR), or a random access channel (RACH) message. In some aspects, the request 712 may be transmitted based on signaling on L1, L2, or L3, where L1 may be the PHY layer, L2 may be the MAC layer or the logical link control layer, and L3 may be the network layer. In some aspects, based on the request 712, the wireless device 704 and the wireless device 702 may accordingly perform resounding 713 for the wireless device 702 to enable a retransmission 708D of transmissions carrying the bundled RSs that could not be transmitted in the RS occasion 708C. In some aspects, the request 712 may be transmitted in or bundled with UE assistance information (UAI), buffer status report (BSR), scheduling request (SR), a hybrid automatic repeat request (HARQ) acknowledgment (ACK), a power headroom report (PHR), or a random access channel (RACH) message.

In some aspects, at 716, the wireless device 702 may be OFF (e.g., unavailable) and may be unable to transmit (e.g., or receive) when the wireless device 702 is unavailable. In some aspects, the wireless device 702 may be unavailable because of at least one of: no power at the wireless device 702, very low power state at the wireless device 702 (e.g., not enough to process the incoming signals or not enough to transmit signals), or the wireless device 702 is performing energy harvesting and unable to perform the energy harvesting and communicating at a same time. After the wireless device 702 powers on (e.g., available) after being OFF, the wireless device 702 may transmit an indication 718 to the wireless device 704 to indicate the time interval where the wireless device 702 is OFF. In some aspects, the indication 718 may indicate the time interval where the wireless device 702 is OFF from a reference point (e.g., a reference transmission) (e.g., OFF during the last X slots, symbols, or time units, X being a positive integer).

In some aspects, the wireless device 702 may receive control information 720 (e.g., SCI or DCI) from the wireless device 704. In some aspects, upon receiving the control information 720, the wireless device 702 may transmit an ACK 722 to the wireless device 704. In some aspects, the wireless device 702 may transmit a representation of energy state or how much time the wireless device 702 may be on along with the ACK 722 (e.g., as part of the ACK 722 or in a separate indication associated with the ACK 722).

In some aspects, the bundling of the set of RSs may be based on EH related information associated with the wireless device 702. For example, the EH related information may include one or more of: EH circuit, EH circuit architecture, RF-to-DC conversion efficiency n, EH parameters such as bands of charging or frequency of charging, charging rate for powering on or communication, or the like. In some aspects, an EH class (e.g., classification of EH device) may be assigned to the wireless device 702 based on the EH related information and the bundling of the set of RSs may be based on the EH class. In some aspects, the bundling of the set of RSs may be based on an energy state (e.g., represented by high level of energy, moderate level of energy, low level of energy, an energy percentage above or below an energy threshold, or the like) of the wireless device 702. In some aspects, based on a change of energy state (e.g., having low energy left), the wireless device 702 may cancel the bundling of the set of RSs (e.g., configured by the RS configuration 706) and transmit a request 714 for canceling the bundling of the set of RSs to the second wireless device 704. In some aspects, the request 714 may be transmitted based on signaling on L1, L2, or L3, where L1 may be the PHY layer, L2 may be the MAC layer or the logical link control layer, and L3 may be the network layer. In some aspects, the request 714 may be transmitted in or bundled with UE assistance information (UAI), buffer status report (BSR), scheduling request (SR), a hybrid automatic repeat request (HARQ) acknowledgment (ACK), a power headroom report (PHR), or a random access channel (RACH) message. In some aspects, the term “cancel” may refer to a scenario where there is RS transmission but no DM-RS, SRS, or other RS bundling (e.g., due to power being different and potentially no coherency) or a scenario where the RS transmission and a transmission (e.g., an associated PUSCH) is not transmitted (e.g., due to having not enough power for transmission).

In some aspects, a time threshold may be specified for the wireless device 702 such that the wireless device 702 might not maintain coherency in a set of bundled RSs after the time threshold. In some aspects, the time threshold may be based on a quantity of symbols, a quantity of slots, or a quantity of time units. In some aspects, the time threshold may be based on EH related information (or EH class) or energy state associated with the wireless device 702. In some aspects, multiple time thresholds may be specified and one of the multiple time thresholds may be selected (e.g., by the wireless device 702 or the wireless device 704) based on the EH related information (or EH class) or energy state associated with the wireless device 702. In some aspects, the time threshold may be a function of the EH class or the energy state associated with the wireless device 702.

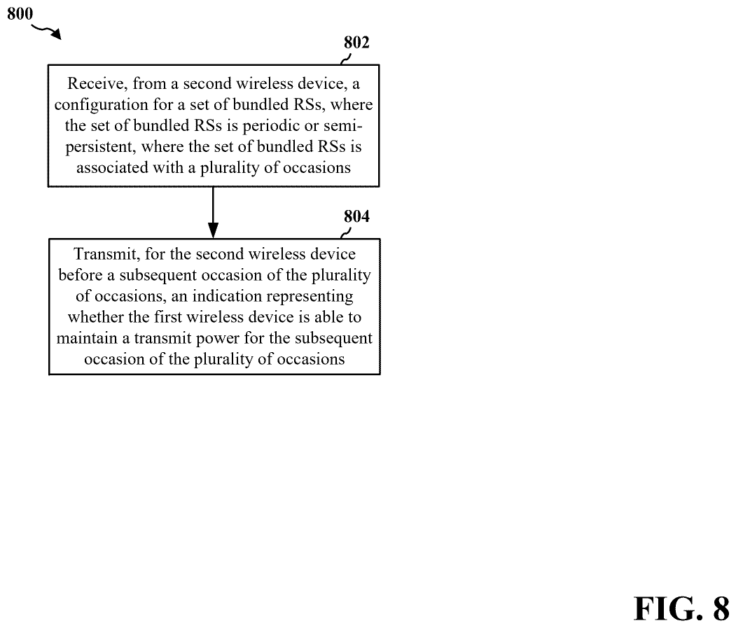

FIG. 8 is a flowchart 800 of a method of wireless communication. The method may be performed by a first wireless device (e.g., the UE 104, the wireless device 702, the apparatus 1204).

At 802, the first wireless device may receive, from a second wireless device, a configuration for a set of bundled RSs, where the set of bundled RSs is periodic or semi-persistent, where the set of bundled RSs is associated with a plurality of occasions. For example, the first wireless device 702 may receive, from a second wireless device 704, a configuration (e.g., 706) for a set of bundled RSs, where the set of bundled RSs is periodic or semi-persistent, where the set of bundled RSs is associated with a plurality of occasions. In some aspects, 802 may be performed by RS component 198.

At 804, the first wireless device may transmit, for the second wireless device before a subsequent occasion of the plurality of occasions, an indication representing whether the first wireless device is able to maintain a transmit power for the subsequent occasion of the plurality of occasions. For example, the first wireless device 702 may transmit, for the second wireless device 704 before a subsequent occasion (e.g., 708A, 708B, or 708C) of the plurality of occasions, an indication (e.g., 710A, 710B, or 710C) representing whether the first wireless device is able to maintain a transmit power for the subsequent occasion of the plurality of occasions. In some aspects, 804 may be performed by RS component 198.

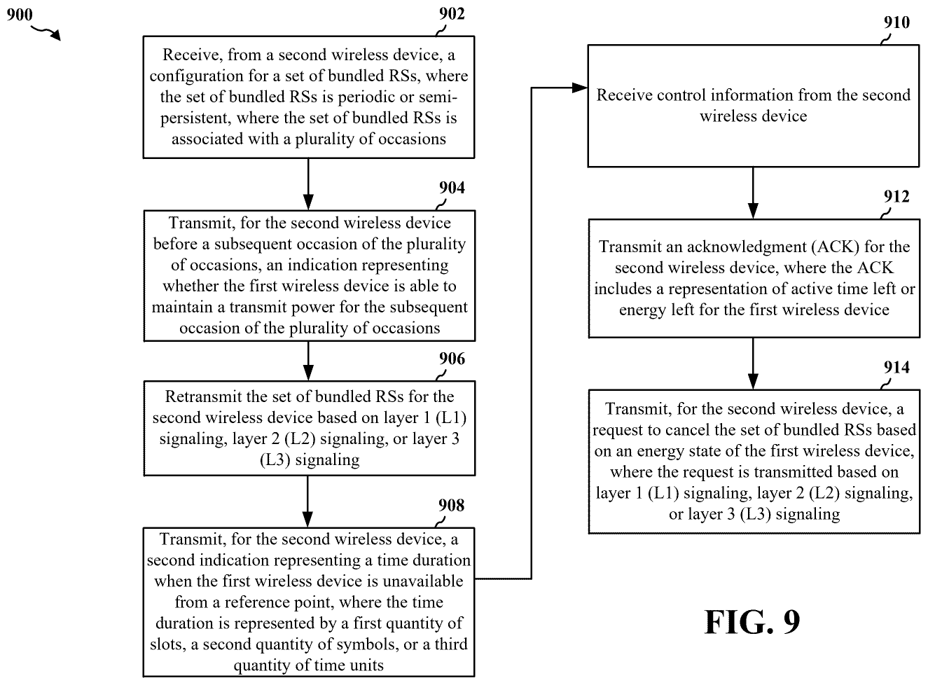

FIG. 9 is a flowchart 900 of a method of wireless communication. The method may be performed by a first wireless device (e.g., the UE 104, the wireless device 702, the apparatus 1204).

At 902, the first wireless device may receive, from a second wireless device, a configuration for a set of bundled RSs, where the set of bundled RSs is periodic or semi-persistent, where the set of bundled RSs is associated with a plurality of occasions. For example, the first wireless device 702 may receive, from a second wireless device 704, a configuration (e.g., 706) for a set of bundled RSs, where the set of bundled RSs is periodic or semi-persistent, where the set of bundled RSs is associated with a plurality of occasions. In some aspects, 902 may be performed by RS component 198.

At 904, the first wireless device may transmit, for the second wireless device before a subsequent occasion of the plurality of occasions, an indication representing whether the first wireless device is able to maintain a transmit power for the subsequent occasion of the plurality of occasions. For example, the first wireless device 702 may transmit, for the second wireless device 704 before a subsequent occasion (e.g., 708A, 708B, or 708C) of the plurality of occasions, an indication (e.g., 710A, 710B, or 710C) representing whether the first wireless device is able to maintain a transmit power for the subsequent occasion of the plurality of occasions. In some aspects, 904 may be performed by RS component 198. In some aspects, the indication represents that the first wireless device is unable to maintain the transmit power for the subsequent occasion, and where the indication is associated with a request of resounding one or more antenna ports associated with the set of bundled RSs to enable a retransmission of the set of bundled RSs. In some aspects, the request further indicates one or more CSI RS resources associated with the one or more antenna ports. In some aspects, the indication representing whether the first wireless device is able to maintain the transmit power for the subsequent occasion of the plurality of occasions is associated with a time duration, where the time duration is associated with a coherency of one or more bundled RSs in the set of bundled RSs, and where the time duration is based on an energy class associated with the first wireless device or an energy state associated with the first wireless device. In some aspects, the set of bundled RSs includes one or more DM-RSs, one or more PRSs, or one or more sounding reference signals SRS. In some aspects, the set of bundled RSs includes the one or more SRSs, and where the indication representing whether the first wireless device is able to maintain the transmit power for the subsequent occasion is based on an allowed power reduction. In some aspects, where the set of bundled RSs is configured to be carried in a single slot or multiple slots, and where the indication is configured to be received before the set of bundled RSs.

At 906, the first wireless device may retransmit the set of bundled RSs for the second wireless device based on layer 1 (L1) signaling, layer 2 (L2) signaling, or layer 3 (L3) signaling. For example, the first wireless device 702 may retransmit (e.g., 708D) the set of bundled RSs for the second wireless device 704 based on layer 1 (L1) signaling, layer 2 (L2) signaling, or layer 3 (L3) signaling. In some aspects, 906 may be performed by RS component 198.

At 908, the first wireless device may transmit, for the second wireless device, a second indication representing a time duration when the first wireless device is unavailable from a reference point, where the time duration is represented by a first quantity of slots, a second quantity of symbols, or a third quantity of time units. For example, the first wireless device 702 may transmit, for the second wireless device 704, a second indication (e.g., 718) representing a time duration when the first wireless device is unavailable from a reference point, where the time duration is represented by a first quantity of slots, a second quantity of symbols, or a third quantity of time units. In some aspects, 908 may be performed by RS component 198. In some aspects, the first wireless device may be unavailable because of at least one of: no power at the first wireless device, very low power state at the first wireless device (e.g., not enough to process the incoming signals or not enough to transmit signals), or the first wireless device is performing energy harvesting and unable to perform the energy harvesting and communicating at a same time.

At 910, the first wireless device may receive control information from the second wireless device, where the control information is one of downlink control information (DCI), sidelink control information (SCI) (e.g., first stage or second stage SCI or a different stage SCI), or uplink control information (UCI). For example, the first wireless device 702 may receive control information (e.g., 720) from the second wireless device, where the control information is one of downlink control information (DCI), sidelink control information (SCI) (e.g., first stage or second stage SCI or a different stage SCI), physical sidelink feedback channel (PSFCH), or uplink control information (UCI). In some aspects, 910 may be performed by RS component 198.

At 912, the first wireless device may transmit an acknowledgment (ACK) for the second wireless device, where the ACK includes a representation of active time left or energy left for the first wireless device. For example, the first wireless device 702 may transmit an acknowledgment (ACK) (e.g., 722) for the second wireless device 704, where the ACK includes a representation of active time left or energy left for the first wireless device. In some aspects, 912 may be performed by RS component 198.

At 914, the first wireless device may transmit, for the second wireless device, a request to cancel the set of bundled RSs based on an energy state of the first wireless device, where the request is transmitted based on layer 1 (L1) signaling, layer 2 (L2) signaling, or layer 3 (L3) signaling. For example, the first wireless device 702 may transmit, for the second wireless device 704, a request (e.g., 714) to cancel the set of bundled RSs based on an energy state (e.g., energy level profile, energy charging profile, energy discharging profile) of the first wireless device, where the request is transmitted based on layer 1 (L1) signaling, layer 2 (L2) signaling, or layer 3 (L3) signaling. In some aspects, 914 may be performed by RS component 198. In some aspects, the request to cancel the set of bundled RSs is based on (e.g., bundled with or transmitted in) UAI, buffer status report (BSR), scheduling request (SR), a hybrid automatic repeat request (HARQ) acknowledgment (ACK), a power headroom report (PHR), or a random access channel (RACH) message.

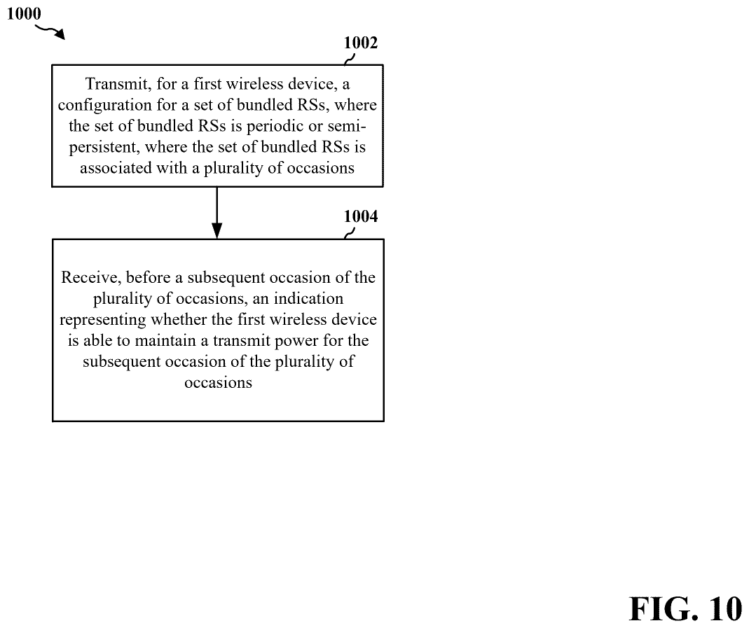

FIG. 10 is a flowchart 1000 of a method of wireless communication. The method may be performed by a network entity (e.g., the base station 102, the wireless device 704, the network entity 1202, the network entity 1302).

At 1002, the second wireless device may transmit, for a first wireless device, a configuration for a set of bundled RSs, where the set of bundled RSs is periodic or semi-persistent, where the set of bundled RSs is associated with a plurality of occasions. For example, the second wireless device 704 may transmit, for a first wireless device 702, a configuration (e.g., 706) for a set of bundled RSs, where the set of bundled RSs is periodic or semi-persistent, where the set of bundled RSs is associated with a plurality of occasions. In some aspects, 1002 may be performed by RS component 199.

At 1004, the second wireless device may receive, before a subsequent occasion of the plurality of occasions, an indication representing whether the first wireless device is able to maintain a transmit power for the subsequent occasion of the plurality of occasions. For example, the second wireless device 704 may receive, before a subsequent occasion (e.g., 708A, 708B, or 708C) of the plurality of occasions, an indication (e.g., 710A, 710B, or 710C) representing whether the first wireless device is able to maintain a transmit power for the subsequent occasion of the plurality of occasions. In some aspects, 1004 may be performed by RS component 199.

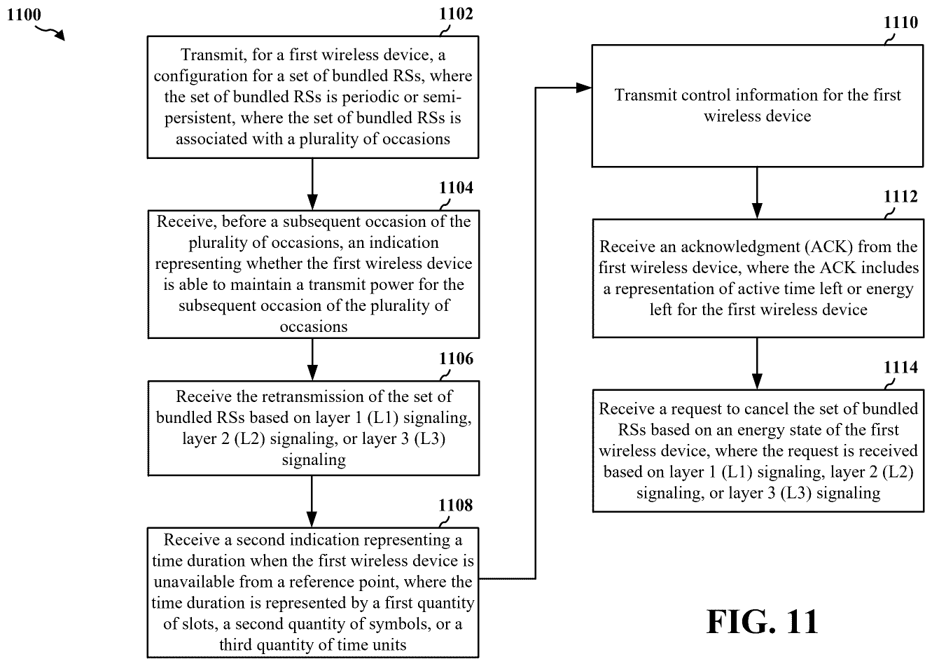

FIG. 11 is a flowchart 1100 of a method of wireless communication. The method may be performed by a network entity (e.g., the base station 102, the wireless device 704, the network entity 1202, the network entity 1302).

At 1102, the second wireless device may transmit, for a first wireless device, a configuration for a set of bundled RSs, where the set of bundled RSs is periodic or semi-persistent, where the set of bundled RSs is associated with a plurality of occasions. For example, the second wireless device 704 may transmit, for a first wireless device 702, a configuration (e.g., 706) for a set of bundled RSs, where the set of bundled RSs is periodic or semi-persistent, where the set of bundled RSs is associated with a plurality of occasions. In some aspects, 1102 may be performed by RS component 199.

At 1104, the second wireless device may receive, before a subsequent occasion of the plurality of occasions, an indication representing whether the first wireless device is able to maintain a transmit power for the subsequent occasion of the plurality of occasions. For example, the second wireless device 704 may receive, before a subsequent occasion (e.g., 708A, 708B, or 708C) of the plurality of occasions, an indication (e.g., 710A, 710B, or 710C) representing whether the first wireless device is able to maintain a transmit power for the subsequent occasion of the plurality of occasions. In some aspects, 1104 may be performed by RS component 199. In some aspects, the indication represents that the first wireless device is unable to maintain the transmit power for the subsequent occasion, and where the indication is associated with a request of resounding one or more antenna ports associated with the set of bundled RSs to enable a retransmission of the set of bundled RSs. In some aspects, the request further indicates one or more CSI RS resources associated with the one or more antenna ports. In some aspects, the indication representing whether the first wireless device is able to maintain the transmit power for the subsequent occasion of the plurality of occasions is associated with a time duration, where the time duration is associated with a coherency of one or more bundled RSs in the set of bundled RSs, and where the time duration is based on an energy class associated with the first wireless device or an energy state associated with the first wireless device. In some aspects, the set of bundled RSs includes one or more DM-RSs, one or more PRSs, or one or more sounding reference signals SRS. In some aspects, the set of bundled RSs includes the one or more SRSs, and where the indication representing whether the first wireless device is able to maintain the transmit power for the subsequent occasion is based on an allowed power reduction. In some aspects, where the set of bundled RSs is configured to be carried in a single slot or multiple slots, and where the indication is configured to be received before the set of bundled RSs.

At 1106, the second wireless device may receive the retransmission of the set of bundled RSs based on layer 1 (L1) signaling, layer 2 (L2) signaling, or layer 3 (L3) signaling. For example, the second wireless device 704 may receive the retransmission (e.g., 708D) of the set of bundled RSs based on layer 1 (L1) signaling, layer 2 (L2) signaling, or layer 3 (L3) signaling. In some aspects, 1106 may be performed by RS component 199.

At 1108, the second wireless device may receive a second indication representing a time duration when the first wireless device is unavailable from a reference point, where the time duration is represented by a first quantity of slots, a second quantity of symbols, or a third quantity of time units. For example, the second wireless device 704 may receive a second indication (e.g., 718) representing a time duration when the first wireless device is unavailable from a reference point, where the time duration is represented by a first quantity of slots, a second quantity of symbols, or a third quantity of time units. In some aspects, 1108 may be performed by RS component 199. In some aspects, the first wireless device may be unavailable because of at least one of: no power at the first wireless device, very low power state at the first wireless device (e.g., not enough to process the incoming signals or not enough to transmit signals), or the first wireless device is performing energy harvesting and unable to perform the energy harvesting and communicating at a same time.

At 1110, the second wireless device may transmit control information for the first wireless device, where the control information is one of downlink control information (DCI), sidelink control information (SCI), or uplink control information (UCI). For example, the second wireless device 704 may transmit control information (e.g., 720) for the first wireless device 702, where the control information is one of downlink control information (DCI), sidelink control information (SCI), feedback control information carried on physical sidelink feedback channel (PSFCH), or uplink control information (UCI). In some aspects, 1110 may be performed by RS component 199.

At 1112, the second wireless device may receive an acknowledgment (ACK) from the first wireless device, where the ACK includes a representation of active time left or energy left for the first wireless device. For example, the second wireless device 704 may receive an acknowledgment (ACK) (e.g., 722) from the first wireless device, where the ACK includes a representation of active time left or energy left for the first wireless device. In some aspects, 1112 may be performed by RS component 199.

At 1114, the second wireless device may receive a request to cancel the set of bundled RSs based on an energy state of the first wireless device, where the request is received based on layer 1 (L1) signaling, layer 2 (L2) signaling, or layer 3 (L3) signaling. For example, the second wireless device 704 may receive a request (e.g., 714) to cancel the set of bundled RSs based on an energy state of the first wireless device, where the request is received based on layer 1 (L1) signaling, layer 2 (L2) signaling, or layer 3 (L3) signaling. In some aspects, 1114 may be performed by RS component 199. In some aspects, the request to cancel the set of bundled RSs is based on (e.g., bundled with or transmitted in) UAI, buffer status report (BSR), scheduling request (SR), a hybrid automatic repeat request (HARQ) acknowledgment (ACK), a power headroom report (PHR), or a random access channel (RACH) message.

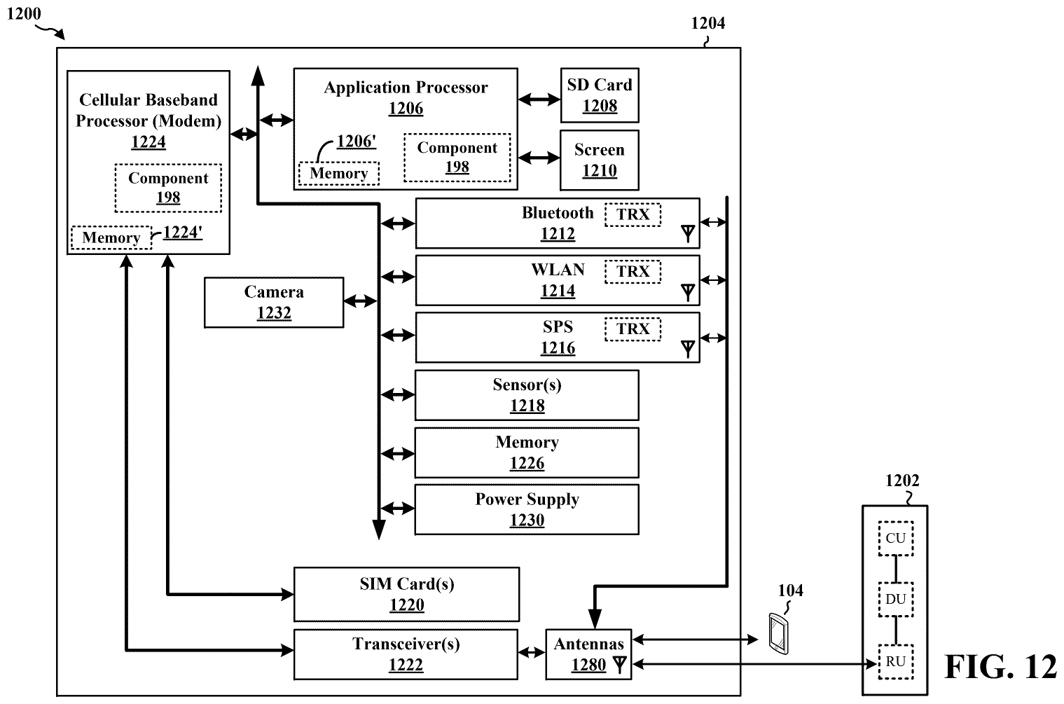

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, a satellite system module 1216 (e.g., GNSS module), one or more sensor modules 1218 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the satellite system module 1216 may include an on-chip transceiver (TRX)/receiver (RX). The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described herein. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed herein, the RS component 198 may be configured to receive, from a second wireless device, a configuration for a set of bundled RSs, where the set of bundled RSs is periodic or semi-persistent, where the set of bundled RSs is associated with a plurality of occasions. In some aspects, the RS component 198 may be further configured to transmit, for the second wireless device before a subsequent occasion of the plurality of occasions, an indication representing whether the first wireless device is able to maintain a transmit power for the subsequent occasion of the plurality of occasions. The RS component 198 may be within the cellular baseband processor 1224, the application processor 1206, or both the cellular baseband processor 1224 and the application processor 1206. The RS component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for receiving, from a second wireless device, a configuration for a set of bundled RSs, where the set of bundled RSs is periodic or semi-persistent, where the set of bundled RSs is associated with a plurality of occasions. In some aspects, the apparatus 1204 may further include means for transmitting, for the second wireless device before a subsequent occasion of the plurality of occasions, an indication representing whether the first wireless device is able to maintain a transmit power for the subsequent occasion of the plurality of occasions. In some aspects, the apparatus 1204 may further include means for retransmitting the set of bundled RSs for the second wireless device based on layer 1 (L1) signaling, layer 2 (L2) signaling, or layer 3 (L3) signaling. In some aspects, the apparatus 1204 may further include means for transmitting, for the second wireless device, a second indication representing a time duration when the first wireless device is unavailable from a reference point, where the time duration is represented by a first quantity of slots, a second quantity of symbols, or a third quantity of time units. In some aspects, the apparatus 1204 may further include means for receiving control information from the second wireless device, where the control information is one of downlink control information (DCI), sidelink control information (SCI), or uplink control information (UCI). In some aspects, the apparatus 1204 may further include means for transmitting an acknowledgment (ACK) for the second wireless device, where the ACK includes a representation of active time left or energy left for the first wireless device. In some aspects, the apparatus 1204 may further include means for transmitting, for the second wireless device, a request to cancel the set of bundled RSs based on an energy state of the first wireless device, where the request is transmitted based on layer 1 (L1) signaling, layer 2 (L2) signaling, or layer 3 (L3) signaling. The means may be the RS component 198 of the apparatus 1204 configured to perform the functions recited by the means. As described herein, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

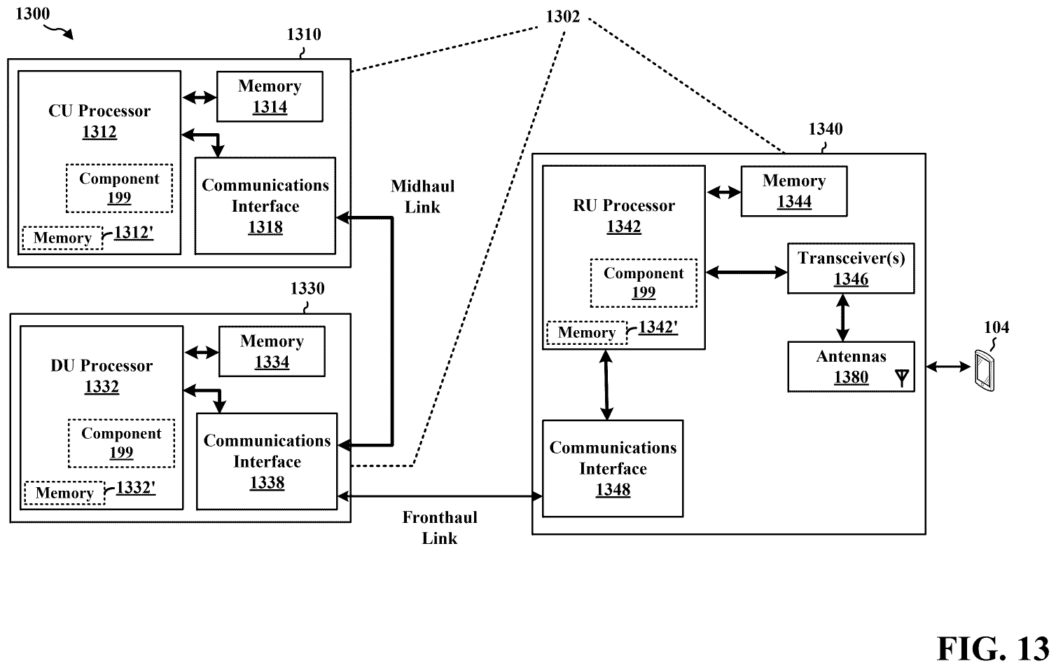

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the RS component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the RS component 199 may be configured to transmit, for a first wireless device, a configuration for a set of bundled RSs, where the set of bundled RSs is periodic or semi-persistent, where the set of bundled RSs is associated with a plurality of occasions. In some aspects, the RS component 199 may be further configured to receive, before a subsequent occasion of the plurality of occasions, an indication representing whether the first wireless device is able to maintain a transmit power for the subsequent occasion of the plurality of occasions. The RS component 199 may be within one or more processors of one or more of the CU 1310, DU 1330, and the RU 1340. The RS component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 includes means for transmitting, for a first wireless device, a configuration for a set of bundled RSs, where the set of bundled RSs is periodic or semi-persistent, where the set of bundled RSs is associated with a plurality of occasions. In some aspects, the network entity 1302 may further include means for receiving, before a subsequent occasion of the plurality of occasions, an indication representing whether the first wireless device is able to maintain a transmit power for the subsequent occasion of the plurality of occasions. In some aspects, the network entity 1302 may further include means for receiving the retransmission of the set of bundled RSs based on layer 1 (L1) signaling, layer 2 (L2) signaling, or layer 3 (L3) signaling. In some aspects, the network entity 1302 may further include means for receiving a second indication representing a time duration when the first wireless device is unavailable from a reference point, where the time duration is represented by a first quantity of slots, a second quantity of symbols, or a third quantity of time units. In some aspects, the network entity 1302 may further include means for transmitting control information for the first wireless device, where the control information is one of downlink control information (DCI), sidelink control information (SCI), or uplink control information (UCI). In some aspects, the network entity 1302 may further include means for receiving an acknowledgment (ACK) from the first wireless device, where the ACK includes a representation of active time left or energy left for the first wireless device. In some aspects, the network entity 1302 may further include means for receiving a request to cancel the set of bundled RSs based on an energy state of the first wireless device, where the request is received based on layer 1 (L1) signaling, layer 2 (L2) signaling, or layer 3 (L3) signaling. The means may be the RS component 199 of the network entity 1302 configured to perform the functions recited by the means. As described herein, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a first wireless device, including: a memory; and at least one processor coupled to the memory and, based at least in part on information stored in the memory, the at least one processor is configured to: receive, from a second wireless device, a configuration for a set of bundled reference signals (RSs), where the set of bundled RSs is periodic or semi-persistent, where the set of bundled RSs is associated with a plurality of occasions; and transmit, for the second wireless device before a subsequent occasion of the plurality of occasions, an indication representing whether the first wireless device is able to maintain a transmit power for the subsequent occasion of the plurality of occasions.

Aspect 2 is the apparatus of aspect 1, where the indication represents that the first wireless device is unable to maintain the transmit power for the subsequent occasion, and where the indication is associated with a request of resounding one or more antenna ports associated with the set of bundled RSs to enable a retransmission of the set of bundled RSs.

Aspect 3 is the apparatus of any of aspects 1-2, where the request further indicates one or more channel state information (CSI) RS resources associated with the one or more antenna ports.

Aspect 4 is the apparatus of any of aspects 1-3, where the at least one processor is further configured to: retransmit the set of bundled RSs for the second wireless device based on layer 1 (L1) signaling, layer 2 (L2) signaling, or layer 3 (L3) signaling.

Aspect 5 is the apparatus of any of aspects 1-4, where the at least one processor is further configured to: transmit, for the second wireless device, a second indication representing a time duration when the first wireless device has is unavailable from a reference point, where the time duration is represented by a first quantity of slots, a second quantity of symbols, or a third quantity of time units.

Aspect 6 is the apparatus of any of aspects 1-5, where the first wireless device is unavailable because of at least one of: no power at the first wireless device, very low power state at the first wireless device, or the first wireless device is performing energy harvesting and unable to perform the energy harvesting and communicating at a same time.

Aspect 7 is the apparatus of any of aspects 1-6, where the at least one processor is further configured to: receive control information from the second wireless device, where the control information is one of downlink control information (DCI), sidelink control information (SCI), or uplink control information (UCI); and transmit an acknowledgment (ACK) for the second wireless device, where the ACK includes a representation of active time left or energy left for the first wireless device.

Aspect 8 is the apparatus of any of aspects 1-7, where the at least one processor is further configured to: transmit, for the second wireless device, a request to cancel the set of bundled RSs based on an energy state of the first wireless device, where the request is transmitted based on layer 1 (L1) signaling, layer 2 (L2) signaling, or layer 3 (L3) signaling.

Aspect 9 is the apparatus of any of aspects 1-8, where the energy state includes at least one of: an energy level profile of the first wireless device including at least one of a current energy value or a future energy value associated with a first predicted duration, an energy charging profile of the first wireless device including at least one of a current energy charging value or a future energy charging value associated with a second predicted duration, or an energy discharging profile of the first wireless device including at least one of a current energy discharging value or a future energy discharging value associated with a third predicted duration.

Aspect 10 is the apparatus of any of aspects 1-9, where the request to cancel the set of bundled RSs is based on user equipment (UE) assistance information (UAI), a buffer status report (BSR), a scheduling request (SR), a hybrid automatic repeat request (HARQ) acknowledgment (ACK), a power headroom report (PHR), or a random access channel (RACH) message.

Aspect 11 is the apparatus of any of aspects 1-10, where the indication representing whether the first wireless device is able to maintain the transmit power for the subsequent occasion of the plurality of occasions is associated with a time duration, where the time duration is associated with a coherency of one or more bundled RSs in the set of bundled RSs, and where the time duration is based on an energy class associated with the first wireless device or an energy state associated with the first wireless device.

Aspect 12 is the apparatus of any of aspects 1-11, where the set of bundled RSs includes one or more demodulation RSs (DM-RSs), one or more positioning reference signals (PRSs), or one or more sounding reference signals (SRSs).

Aspect 13 is the apparatus of any of aspects 1-12, where the set of bundled RSs includes the one or more SRSs, and where the indication representing whether the first wireless device is able to maintain the transmit power for the subsequent occasion is based on an allowed power reduction.

Aspect 14 is the apparatus of any of aspects 1-13, where the set of bundled RSs is configured to be carried in a single slot or multiple slots, and where the indication is configured to be transmitted before the set of bundled RSs.

Aspect 15 is the apparatus of any of aspects 1-14, where the first wireless device is a first user equipment (UE) or a first network entity, and where the second wireless device is a second UE or a second network entity.

Aspect 16 is the apparatus of any of aspects 1-15, further including a transceiver or an antenna coupled to the at least one processor, and where the transceiver or the antenna is configured to receive the configuration for the set of bundled RSs.

Aspect 17 is an apparatus for wireless communication at a second wireless device, including: a memory; and at least one processor coupled to the memory and, based at least in part on information stored in the memory, the at least one processor is configured to: transmit, for a first wireless device, a configuration for a set of bundled reference signals (RSs), where the set of bundled RSs is periodic or semi-persistent, where the set of bundled RSs is associated with a plurality of occasions; and receive, before a subsequent occasion of the plurality of occasions, an indication representing whether the first wireless device is able to maintain a transmit power for the subsequent occasion of the plurality of occasions.

Aspect 18 is the apparatus of aspect 17, where the indication represents that the first wireless device is unable to maintain the transmit power for the subsequent occasion, and where the indication is associated with a request of resounding one or more antenna ports associated with the set of bundled RSs to enable a retransmission of the set of bundled RSs.

Aspect 19 is the apparatus of any of aspects 17-18, where the request further indicates one or more channel state information (CSI) RS resources associated with the one or more antenna ports.

Aspect 20 is the apparatus of any of aspects 17-19, where the at least one processor is further configured to: receive the retransmission of the set of bundled RSs based on layer 1 (L1) signaling, layer 2 (L2) signaling, or layer 3 (L3) signaling.

Aspect 21 is the apparatus of any of aspects 17, where the at least one processor is further configured to: receive a second indication representing a time duration when the first wireless device is unavailable from a reference point, where the time duration is represented by a first quantity of slots, a second quantity of symbols, or a third quantity of time units.

Aspect 22 is the apparatus of any of aspects 17-21, where the at least one processor is further configured to: transmit control information for the first wireless device, where the control information is one of downlink control information (DCI), sidelink control information (SCI), or uplink control information (UCI); and receive an acknowledgment (ACK) from the first wireless device, where the ACK includes a representation of active time left or energy left for the first wireless device.

Aspect 23 is the apparatus of any of aspects 17-22, where the at least one processor is further configured to: receive a request to cancel the set of bundled RSs based on an energy state of the first wireless device, where the request is received based on layer 1 (L1) signaling, layer 2 (L2) signaling, or layer 3 (L3) signaling.

Aspect 24 is the apparatus of any of aspects 17-23, where the energy state includes at least one of: an energy level profile of the first wireless device including at least one of a current energy value or a future energy value associated with a first predicted duration, an energy charging profile of the first wireless device including at least one of a current energy charging value or a future energy charging value associated with a second predicted duration, or an energy discharging profile of the first wireless device including at least one of a current energy discharging value or a future energy discharging value associated with a third predicted duration.

Aspect 25 is the apparatus of any of aspects 17-24, where the request to cancel the set of bundled RSs is based on user equipment (UE) assistance information (UAI), a buffer status report (BSR), a scheduling request (SR), a hybrid automatic repeat request (HARQ) acknowledgment (ACK), a power headroom report (PHR), or a random access channel (RACH) message.

Aspect 26 is the apparatus of any of aspects 17-25, where the indication representing whether the first wireless device is able to maintain the transmit power for the subsequent occasion of the plurality of occasions is associated with a time duration, where the time duration is associated with a coherency of one or more bundled RSs in the set of bundled RSs, and where the time duration is based on an energy class associated with the first wireless device or an energy state associated with the first wireless device.

Aspect 27 is the apparatus of any of aspects 17-26, where the set of bundled RSs includes one or more demodulation RSs (DM-RSs), one or more positioning reference signals (PRSs), or one or more sounding reference signals (SRSs).

Aspect 28 is the apparatus of any of aspects 17-27, where the set of bundled RSs includes the one or more SRSs, and where the indication representing whether the first wireless device is able to maintain the transmit power for the subsequent occasion is based on an allowed power reduction.

Aspect 29 is the apparatus of any of aspects 17-28, where the set of bundled RSs is configured to be carried in a single slot or multiple slots, and where the indication is configured to be received before the set of bundled RSs.

Aspect 30 is the apparatus of any of aspects 17-29, where the first wireless device is a first user equipment (UE) or a first network entity, and where the second wireless device is a second UE or a second network entity.

Aspect 31 is the apparatus of any of aspects 17-30, further including a transceiver or an antenna coupled to the at least one processor, and where the transceiver or the antenna is configured to transmit the configuration for the set of bundled RSs.

Aspect 32 is a method of wireless communication for implementing any of aspects 1 to 16.

Aspect 33 is an apparatus for wireless communication including means for implementing any of aspects 1 to 16.

Aspect 34 is a computer-readable medium (e.g., a non-transitory computer-readable medium) storing computer executable code, where the code when executed by a processor causes the processor to implement any of aspects 1 to 16.

Aspect 35 is a method of wireless communication for implementing any of aspects 17 to 31.

Aspect 36 is an apparatus for wireless communication including means for implementing any of aspects 17 to 31.

Aspect 37 is a computer-readable medium (e.g., a non-transitory computer-readable medium) storing computer executable code, where the code when executed by a processor causes the processor to implement any of aspects 17 to 31.

1. An apparatus for wireless communication at a first wireless device, comprising:
one or more memories; and
one or more processors coupled to the one or more memories and, based at least in part on information stored in the one or more memories, the one or more processors are individually or collectively configured to cause the first device to:
receive, from a second wireless device, a configuration for a set of bundled reference signals (RSs), wherein the set of bundled RSs is periodic or semi-persistent, wherein the set of bundled RSs is associated with a plurality of occasions; and
transmit, for the second wireless device before a subsequent occasion of the plurality of occasions, an indication representing whether the first wireless device is able to maintain a transmit power for the subsequent occasion of the plurality of occasions.

2. The apparatus of claim 1, wherein the indication represents that the first wireless device is unable to maintain the transmit power for the subsequent occasion, and wherein the indication is associated with a request of resounding one or more antenna ports associated with the set of bundled RSs to enable a retransmission of the set of bundled RSs.

3. The apparatus of claim 2, wherein the request further indicates one or more channel state information (CSI) RS resources associated with the one or more antenna ports.

4. The apparatus of claim 2, wherein the one or more processors are individually or collectively configured to cause the first device to:
retransmit the set of bundled RSs for the second wireless device based on layer 1 (L1) signaling, layer 2 (L2) signaling, or layer 3 (L3) signaling.

5. The apparatus of claim 1, wherein the one or more processors are individually or collectively configured to cause the first device to:
transmit, for the second wireless device, a second indication representing a time duration when the first wireless device has is unavailable from a reference point, wherein the time duration is represented by a first quantity of slots, a second quantity of symbols, or a third quantity of time units.

6. The apparatus of claim 5, wherein the first wireless device is unavailable because of at least one of: no power at the first wireless device, very low power state at the first wireless device, or the first wireless device is performing energy harvesting and unable to perform the energy harvesting and communicating at a same time.

7. The apparatus of claim 1, wherein the one or more processors are individually or collectively configured to cause the first device to:
receive control information from the second wireless device, wherein the control information is one of downlink control information (DCI), sidelink control information (SCI), or uplink control information (UCI); and
transmit an acknowledgment (ACK) for the second wireless device, wherein the ACK comprises a representation of active time left or energy left for the first wireless device.

8. The apparatus of claim 1, wherein the one or more processors are individually or collectively configured to cause the first device to:
transmit, for the second wireless device, a request to cancel the set of bundled RSs based on an energy state of the first wireless device, wherein the request is transmitted based on layer 1 (L1) signaling, layer 2 (L2) signaling, or layer 3 (L3) signaling.

9. The apparatus of claim 8, wherein the energy state comprises at least one of: an energy level profile of the first wireless device including at least one of a current energy value or a future energy value associated with a first predicted duration, an energy charging profile of the first wireless device including at least one of a current energy charging value or a future energy charging value associated with a second predicted duration, or an energy discharging profile of the first wireless device including at least one of a current energy discharging value or a future energy discharging value associated with a third predicted duration.

10. The apparatus of claim 8, wherein the request to cancel the set of bundled RSs is based on user equipment (UE) assistance information (UAI), a buffer status report (BSR), a scheduling request (SR), a hybrid automatic repeat request (HARQ) acknowledgment (ACK), a power headroom report (PHR), or a random access channel (RACH) message.

11. The apparatus of claim 1, wherein the indication representing whether the first wireless device is able to maintain the transmit power for the subsequent occasion of the plurality of occasions is associated with a time duration, wherein the time duration is associated with a coherency of one or more bundled RSs in the set of bundled RSs, and wherein the time duration is based on an energy class associated with the first wireless device or an energy state associated with the first wireless device.

12. The apparatus of claim 1, wherein the set of bundled RSs comprises one or more demodulation RSs (DM-RSs), one or more positioning reference signals (PRSs), or one or more sounding reference signals (SRSs).

13. The apparatus of claim 12, wherein the set of bundled RSs comprises the one or more SRSs, and wherein the indication representing whether the first wireless device is able to maintain the transmit power for the subsequent occasion is based on an allowed power reduction.

14. The apparatus of claim 1, wherein the set of bundled RSs is configured to be carried in a single slot or multiple slots, and wherein the indication is configured to be transmitted before the set of bundled RSs.

15. The apparatus of claim 1, wherein the first wireless device is a first user equipment (UE) or a first network entity, and wherein the second wireless device is a second UE or a second network entity.

16. The apparatus of claim 1, further comprising a transceiver or an antenna coupled to the one or more processors, and wherein the transceiver or the antenna is configured to receive the configuration for the set of bundled RSs.

17. An apparatus for wireless communication at a second wireless device, comprising:
one or more memories; and
one or more processors coupled to the one or more memories and, based at least in part on information stored in the one or more memories, the one or more processors are individually or collectively configured to cause the second device to:
transmit, for a first wireless device, a configuration for a set of bundled reference signals (RSs), wherein the set of bundled RSs is periodic or semi-persistent, wherein the set of bundled RSs is associated with a plurality of occasions; and
receive, before a subsequent occasion of the plurality of occasions, an indication representing whether the first wireless device is able to maintain a transmit power for the subsequent occasion of the plurality of occasions.

18. The apparatus of claim 17, wherein the indication represents that the first wireless device is unable to maintain the transmit power for the subsequent occasion, and wherein the indication is associated with a request of resounding one or more antenna ports associated with the set of bundled RSs to enable a retransmission of the set of bundled RSs.

19. The apparatus of claim 18, wherein the request further indicates one or more channel state information (CSI) RS resources associated with the one or more antenna ports.

20. The apparatus of claim 18, wherein the one or more processors are individually or collectively configured to cause the second device to:
receive the retransmission of the set of bundled RSs based on layer 1 (L1) signaling, layer 2 (L2) signaling, or layer 3 (L3) signaling.

21-30. (canceled)
